(19) United States
(12) Patent Application Publication
(10) Pub. No.: US 2024/0290595 A1
(43) Pub. Date: Aug. 29, 2024

(54) MS Calibration for OPI-MS

(71) Applicant: DH Technologies Development Pte. Ltd., Singapore (SG)

(72) Inventors: Thomas COVEY, Concord (CA); Chang LIU, Richmond Hill (CA)

(21) Appl. No.: 18/568,404

(22) PCT Filed: Jun. 8, 2022
(86) PCT No.: PCT/IB2022/055352

§ 371 Date: Dec. 8, 2023

Related U.S. Application Data
(60) Provisional application No. 63/208,709, filed on Jun. 9, 2021.

(51) Int. Cl. H01J 49/00; H01J 49/04

(52) U.S. Cl. CPC H01J 49/0009; H01J 49/0404

(57) ABSTRACT

In one aspect, a calibration system for use in a mass spectrometer having an open port interface (OPI) for receiving a sample for mass analysis is disclosed, which includes a fluidic junction having a first inlet in fluid communication with a first reservoir, which is configured for storing a calibration liquid, and a second inlet in fluid communication with a second reservoir, which is configured for storing a transport liquid. The fluidic junction can further include an outlet in fluid communication with the first and second inlets such that any of the calibration liquid and the transport liquid can exit the fluidic junction via said outlet.

### BACKGROUND

The present disclosure is directed generally to systems and methods for calibrating/tuning a mass spectrometer.

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

To ensure the mass accuracy, resolution, and other analytical merits of a mass spectrometer within acceptable specifications, regular calibration and tuning of a mass spectrometer are required. The rate at which such calibration and/or tuning needs to be performed depends on the type of the mass spectrometer. For example, high resolution mass spectrometers (e.g., time-of-flight (TOF) mass spectrometers) typically require more frequent tuning.

Hence, there is a need for improved systems and methods for calibrating/tuning a mass spectrometer.

### SUMMARY

In one aspect, a calibration system for use in a mass spectrometer having an open port interface (OPI) for receiving a sample for mass analysis is disclosed, which includes a fluidic junction having a first inlet in fluid communication with a first reservoir, which is configured for storing a calibration liquid, and a second inlet in fluid communication with a second reservoir, which is configured for storing a transport liquid. The fluidic junction can further include an outlet in fluid communication with the first and second inlets such that any of the calibration liquid and the transport liquid can exit the fluidic junction via said outlet.

A first pump is operably coupled to the first reservoir for causing a flow of the calibration liquid from that reservoir to the first inlet for introduction into the fluidic junction and a second pump that is operably coupled to the second reservoir for causing a flow of the transport liquid from the second reservoir to the second inlet for introduction into the fluidic junction. The calibration system can further include a controller that is operably coupled to the first pump for controlling operation thereof.

In an embodiment, a second pump can be operably coupled to the second reservoir for causing flow of the transport liquid from the second reservoir to the second inlet of the fluidic junction to introduce the transport liquid into the fluidic junction. The transport liquid can then be transported from the fluidic junction into the OPI.

In some embodiments, the controller can adjust the pumping speed of any of the first and the second pump so as to inhibit an overflow of a mixture of the calibration liquid and the transport liquid at the liquid/air interface of the OPI. More generally, the controller may be configured to maintain substantially uniform liquid surface conditions (e.g., similar vortex, not overflow) within the OPI.

By way of example, the controller may be configured to adjust the speed of the second pump so as to reduce the flowrate of the transport liquid during at least a portion of a temporal period during which the second pump is in an activated state. By way of example, the controller can be configured to adjust the speed of the second pump so as to reduce the flowrate of the transport liquid prior to activation of the first pump, which causes the flow of the calibration liquid. In some cases, the controller is configured to adjust the speed of the second pump so as to reduce the flowrate of the transport liquid substantially concurrently with the activation of the first pump. Further, in some embodiments, the controller may be configured to adjust the speed of the second pump to reduce the flowrate of the transport liquid after the activation of the first pump.

In some embodiments, the system may further include at least one flow monitor that is operably coupled to any of the two inlets and/or the outlet of the fluidic junction to monitor the flowrate of the transport liquid and/or calibration liquid into the fluidic junction and/or monitor the flow of the transport liquid and/or a mixture of the transport liquid and the calibration liquid out of the fluidic junction via its outlet for introduction into the OPI.

In some embodiments, the controller may be in communication with the flow monitor to receive one or more signals generated by the flow monitor that are indicative of the flowrate of the liquid (e.g., transport liquid and/or the calibration liquid). In some such embodiments, the controller can process these signals to determine the flowrate(s) of liquid being introduced into the OPI. By way of example, if the controller determines, via such monitoring of the flowrate(s), that there is a risk of liquid overflow at the liquid/air interface of the OPI, the controller can adjust the pumping speed of the second pump (i.e., the pump that causes the flow of the transport liquid into the fluidic junction) so as to reduce the flowrate of the transport liquid into the OPI in order to inhibit a potential liquid overflow at the liquid/air interface of the OPI.

In some embodiments, the controller can utilize the measurement signal(s) generated by the flow monitor to maintain the flowrate of liquid into the OPI at a substantially constant level. By way of example, in some such embodiments, in response to a flowrate measurement that indicates a liquid flowrate greater than a predefined threshold, the controller can reduce the pumping speed of the second pump to reduce the flowrate of the transport liquid into the OPI.

In a related aspect, a mass spectrometer is disclosed, which includes an open port interface (OPI) for receiving a sample, a first reservoir for storing a calibration liquid, a second reservoir for storing a transport liquid, and a fluidic junction having a first inlet configured for fluid coupling with the first reservoir for receiving the transport liquid and a second inlet configured for fluid coupling with the second reservoir for receiving the calibration liquid, said fluidic junction further having an outlet in fluid communication with the first and second inlets and further configured for fluid communication with the OPI for the introduction of any of the transport liquid, the calibration liquid and a mixture thereof into said OPI. A first pump may be operably coupled to the first reservoir for causing a flow of the calibration liquid into the fluidic junction. The mass spectrometer can also include a controller that is operably coupled to the first pump for controlling operation thereof.

The controller can be configured for activating the first pump to cause a flow of the calibration liquid into said fluidic junction for calibrating said mass spectrometer.

In some embodiments, the mass spectrometer can include a second pump that is operably coupled to the second reservoir for causing a flow of the transport liquid into the fluid junction. The controller can be operably coupled to the second pump for controlling its operation. In some such embodiments, the controller can be configured to adjust a speed of the second pump so as to inhibit a potential liquid overflow at the liquid/air interface of the OPI. By way of example, the controller can be configured to send one or more signals to the second pump so as to reduce that pump's speed and hence reduce the flowrate of the transport liquid into the fluidic junction during at least a portion of a temporal period during which the first pump is in an activated state. For example, in some embodiments, the controller can be configured to reduce the flowrate of the transport liquid into the fluidic junction, and hence the OPI, prior to activation of the pump, that causes the flow of the calibration solution into the fluidic junction, and hence into the OPI. Alternatively, the controller can reduce the flowrate of the transport liquid into the fluidic junction, and hence the flowrate of the transport liquid into the OPI, substantially concurrently with the activation of the pump that causes the flow of the calibration solution into the fluidic junction.

In some embodiments, the OPI can include an outer conduit and an inner conduit, where the outer conduit is configured to receive a liquid (e.g., the transport liquid or a mixture of the transport liquid and a calibration solution), e.g., via the outlet of the fluidic junction, and deliver the liquid to the an inlet of the inner conduit in a sampling space at a liquid/air interface of the OPI. In some embodiments, the controller is configured to reduce the speed of the second pump substantially concurrently with the activation of the pump that is employed for causing the flow of the calibration solution.

In some embodiments, a sample reservoir for storing a target sample is operably coupled to an acoustic transducer, which can be activated to cause ejection of portions of the sample stored in that reservoir into the sampling space of the OPI such that the ejected portions of the sample are introduced into the inlet of the inner conduit of the OPI and are entrained within a flow of the transport liquid to be transported to an outlet of said inner conduit of the OPI.

An ion source is positioned downstream of the outlet of the inner conduit of the OPI to receive at least a portion of the sample exiting through the outlet of the inner conduit and to ionize at least a portion of the received sample to generate a plurality of ions. In some embodiments, the ion source can be an electrospray ion (ESI) source. Further, at least one mass analyzer positioned downstream of the ion source can receive at least a portion of the generated ions. In some embodiments, the mass analyzer can be a time-of-flight (TOF) mass analyzer, though other mass analyzers, such as quadrupole mass analyzers or a combination of quadrupole and time-of-flight mass analyzers may also be employed.

In a related aspect, a method for calibrating a mass spectrometer having an OPI for receiving a sample is disclosed, which includes introducing a transport liquid into a fluidic junction via a first inlet thereof such that the transport liquid flows from the first inlet to an outlet of the fluidic junction that is in communication with the OPI for introduction of the transport liquid into the OPI, and introducing a calibration liquid containing a calibration standard (e.g., a mixture (such as solution) of the calibration standard and a solvent) into the fluidic junction via a second inlet thereof to be mixed with the transport liquid for introduction into the OPI via the outlet of the fluidic junction. The transport liquid can be received by the OPI via one conduit and can be entrained within the flow of the transport liquid to be transferred, via another conduit of the OPI that is in fluid communication with the first conduit at an open liquid/air interface of the OPI, into a downstream ion source. The calibration standard can undergo ionization in the downstream ion source and the generated ions can be detected and analyzed to determine one or more operational characteristics of the mass spectrometer, such as sensitivity and mass resolution. In some embodiments, a detected m/z ratio for the calibration standard (and/or one or more fragments of the calibration standard) can be compared with a theoretical m/z ratio of the calibration standard (and/or those of its fragments) for tuning/calibrating (e.g., auto-calibration) of the mass spectrometer. In some cases, various parameters of a mass spectrometer (such as DC and RF voltages applied to various components (e.g., ion guides)) may be adjusted until the measured m/z ratio of the calibration standard (and/or its fragments) is within an acceptable range of the associated theoretical values of the m/z ratios. In some embodiments, in response to the determination of such characteristics, one or more operating parameters of the mass spectrometer, such as various voltages applied to one or more ion guides and/or mass analyzers, may be adjusted to improve the measured characteristic(s) of the mass spectrometer.

In a related aspect, a system for calibrating a mass spectrometer having an open port interface (OPI) for receiving a sample for analysis is disclosed, which includes a fluidic junction having a first inlet for receiving a carrier liquid (transport liquid) and a second inlet for receiving a calibration liquid (e.g., a mixture of a calibration standard and a solvent), where the fluidic junction can further include an outlet in fluid communication with said first and second inlets through which any of the carrier liquid and the calibration liquid can exit for introduction into the OPI. A first conduit can transfer the calibration liquid from a calibration reservoir to the first inlet. A first pump operably coupled to the first conduit can provide a motive force for causing the flow of the calibration liquid into the fluidic junction. A controller is operably coupled to the first pump for activating the first pump for transferring the calibration liquid into the fluidic junction for calibrating the mass spectrometer.

A second conduit extends from an inlet for receiving the carrier liquid to an outlet that is fluidly coupled to the second inlet of the fluidic junction for delivering the carrier liquid to the fluidic junction. The carrier liquid flows through the outlet of the fluidic junction for introduction into the OPI. A second pump may be operably coupled to the second conduit for providing a motive force for causing the flow of the carrier liquid from a reservoir storing the carrier liquid into the fluidic junction. A controller is operably coupled to the second pump for adjusting the flowrate of the carrier liquid through the second conduit.

By way of example, in some embodiments, the controller can be configured to adjust the speed of the second pump so as to reduce the flowrate of the carrier liquid during at least a portion of a temporal period during which the second pump is in an activated state. For example, the controller may be configured to reduce the flowrate of the carrier liquid prior to causing the activation of the first pump, alternatively, the controller may be configured to reduce the flowrate of the carrier liquid substantially concurrently with the activation of the first pump.

In a related aspect, a calibration system for use in a mass spectrometer having an open port interface (OPI) for receiving a sample for mass analysis is disclosed, where said OPI includes a liquid supply conduit configured to receive a transport liquid and configured to be in fluid communication with a liquid exhaust conduit at a liquid/air interface for introduction of the transport liquid into the liquid exhaust conduit. The calibration system includes at least one reservoir for storing a calibration standard, said reservoir having an outlet through which the calibration standard can exit the reservoir. A fluid channel provides a fluid path between the outlet of the reservoir and a port provided on the an outer wall of said OPI for directing the calibration standard into a transport liquid flowing through the liquid supply conduit.

A pump can be operably coupled to the reservoir for providing a motive force for causing a flow of the calibration liquid into the liquid supply conduit.

Further understanding of various aspects of the present teachings can be obtained by reference to the following detailed description in connection with the associated drawings, which are described briefly below.

### BRIEF DESCRIPTION OF THE DRAWINGS

FIG. 1 is a flowchart depicting various steps in an embodiment of a method according to the present teachings for calibrating/tuning a mass spectrometer,

FIG. 2A schematically depicts a calibration/tuning system according to an embodiment for calibrating/tuning a mass spectrometer, which utilizes an OPI sampling probe for receiving a sample for mass analysis,

FIG. 2B schematically depicts a calibration/tuning system according to another embodiment in which a plurality of different calibration standards are employed,

FIG. 3 schematically depicts a mass spectrometer in which a calibration/tuning system according to an embodiment of the present teachings is incorporated,

FIG. 4 schematically depicts a calibration/tuning system according to another embodiment of the present teachings, and

FIG. 5 schematically depicts an implementation example of a controller/analyzer, which can be used in the practice of various embodiments of the present teachings.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed an any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”.

The present disclosure is generally directed to systems and methods for calibrating and/or tuning a mass spectrometer. The calibration/tuning of a mass spectrometer is typically achieved by infusing a calibration standard (herein also referred to as a calibrant) into an ion source of the mass spectrometer and adjusting various parameters of the mass spectrometer, if needed, to generate a continuous stable signal. By way of example, the calibrant may be introduced into the ion source through the same probe/electrode as the one used for regular sample analysis or through a separate probe and/or electrode, which is configured for use in calibrating/tuning the mass spectrometer. Such a separate probe and/or electrode is typically employed in high resolution mass spectrometers, which require more frequent calibration/tuning. Some examples of such additional probes/electrodes for MS calibration include the Duo Spray Ion Source, which provides separate probe and electrode, the Twin electrode configuration, which provides two electrodes with the same probe.

An aspect of the present disclosure is the recognition that for ion sources in which the installment of an additional probe for MS tuning/calibration is difficult, enhanced systems and methods for performing calibration/tuning are needed. For example, the analytical performance, such as throughput, sensitivity, reproducibility, etc. of mass spectrometers that employ an open port interface (OPI) for receiving a sample and employ an electrospray ion source (ESI) for ionizing the sample (e.g., the Echo MS system of Sciex) is directly related to the aspiration force that is created by the nebulizer gas at the ESI nozzle. The installment of another electrode for use in MS tuning/calibration can restrict the flowrate of the nebulizer gas and can hence lead to a weaker aspiration force. As such, it is preferable not to install an additional electrode within the same probe.

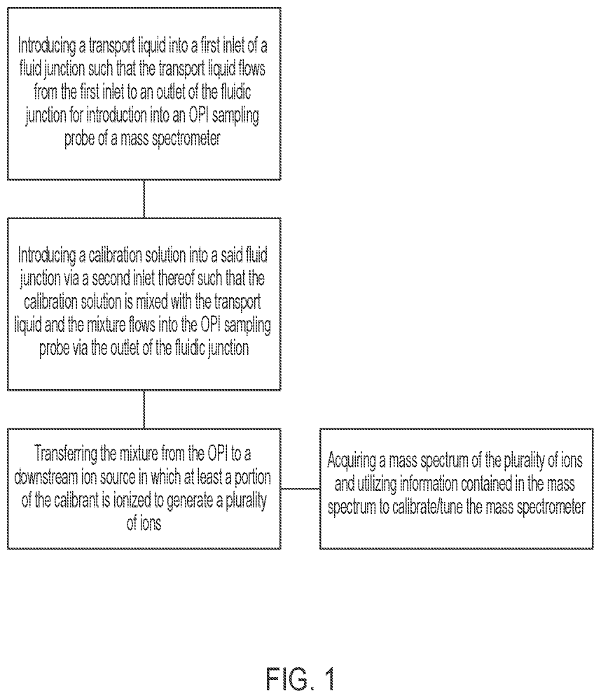

FIG. 1 illustrates a flow chart depicting various steps of a method according to an embodiment for calibrating/tuning a mass spectrometer that employs an OPI for receiving a sample for which mass analysis is desired. In an embodiment of such a method, a calibration solution (e.g., a solution of a calibration standard and a solvent) can be introduced into a fluidic junction (e.g., a T junction) via a first inlet. A transport liquid (which is herein also referred to as a carrier liquid) can be introduced into the fluidic junction (e.g., a T junction) via a second inlet thereof such that the transport liquid flows from the second inlet of the fluidic junction to an outlet thereof, which is in fluid communication with the OPI. During a calibration/tuning process, the calibration solution is mixed with the transport liquid and the mixture (or at least a portion thereof) is transferred to a downstream ion source, where the calibration standard (or at least a portion thereof) is ionized to generate a plurality of ions. A mass spectrum of the plurality of the ions is generated and the information contained in the mass spectrum is analyzed to calibrate/tune the mass spectrometer.

In some embodiments of the above method, the flowrate of the transport liquid and/or the calibration solution may be adjusted to inhibit the potential for liquid overflow at the liquid/air interface of the OPI. By way of example, in some embodiments, during at a least a portion of a temporal period during which the mixture of the calibration solution and the transport liquid is introduced into the OPI, the flowrate of the transport liquid introduced into the OPI is reduced, e.g., by adjusting the speed of a pump that provides a motive force for generating a flow of the transport liquid, so as to inhibit a potential liquid overflow at the liquid/air interface of the OPI at which the mixture is introduced into a conduit of the OPI through which it is transferred into a downstream ion source to be ionized.

By way of example, in some embodiments, the flowrate of the mixture into the OPI sampling probe may be in a range of about 100 μL/min to about 2000 μL/min. Such a flowrate of the mixture may be achieved, for example, via adjustment of the flowrate of the calibration solution and/or the transport liquid.

The introduction of the transport liquid and the calibration solution into the fluidic junction can be caused by a suitable pump, such as those listed herein.

In another embodiment, rather than utilizing a fluidic junction, the calibration solution may be introduced directly into a liquid supply conduit of the OPI to be mixed with a transport liquid flowing through that liquid supply conduit. The mixture (or at least a portion thereof) flows into a liquid exhaust conduit of the OPI via an inlet of the liquid exhaust conduit positioned in a sampling region at a liquid/air interface of the OPI to be introduced into a downstream ion source in which the calibration standard (or at least a portion thereof) is ionized to generate a plurality of ions. One or more downstream mass analyzers can perform mass analysis of the ions to generate a mass spectrum thereof and the mass peaks associated with the detected ions can be analyzed for calibration/tuning of the mass spectrometer.

A variety of calibration standards may be employed in the practice of various embodiments. Some examples of suitable calibration standards include, without limitation, aminoheptanoic acid, amino-dPEG 4-acid, clomipramine, amino-dPEG 6-acid, amino-dPEG 8-acid, amino-dPEG 12-acid, reserpine, Hexakis(2,2,3,3-tetrafluoropropoxy) phosphazene, Hexakis(1H, 1H,5H-octafluoropentoxy) phosphazene, among others. The choice of a particular calibration standard may depend on various considerations, such as the type of an ion source and/or a mass analyzer employed in the mass spectrometer.

The calibration standard may be mixed with a solvent to provide a calibration solution. In some embodiments, the concentration of the calibration standard in the calibration solution may be selected, e.g., based on the characteristics (e.g., sensitivity and/or resolution) of the mass spectrometer to be calibrated/tuned.

In some embodiments, different calibration standards (multiple types) may be used to tune/calibrate different components or different operational modes of a mass spectrometer. For example, different calibration standards may be utilized to calibrate/tune a positive ion mode or a negative ion mode of a mass spectrometer and/or to calibrate/tune the Quadrapole part or the TOF part of a hybrid mass spectrometer. By way of example, in some embodiments, multiple reservoirs can be utilized for storing calibration solutions containing different calibration standards. In some such embodiments, a valve structure (e.g., a fluidic manifold) may be utilized to selectively couple each reservoir to an inlet of a fluidic junction so as to introduce a calibration solution into the fluid junction to be mixed with a transport liquid introduced into the fluid junction via another inlet such that the mixture will exit the fluid junction via its outlet.

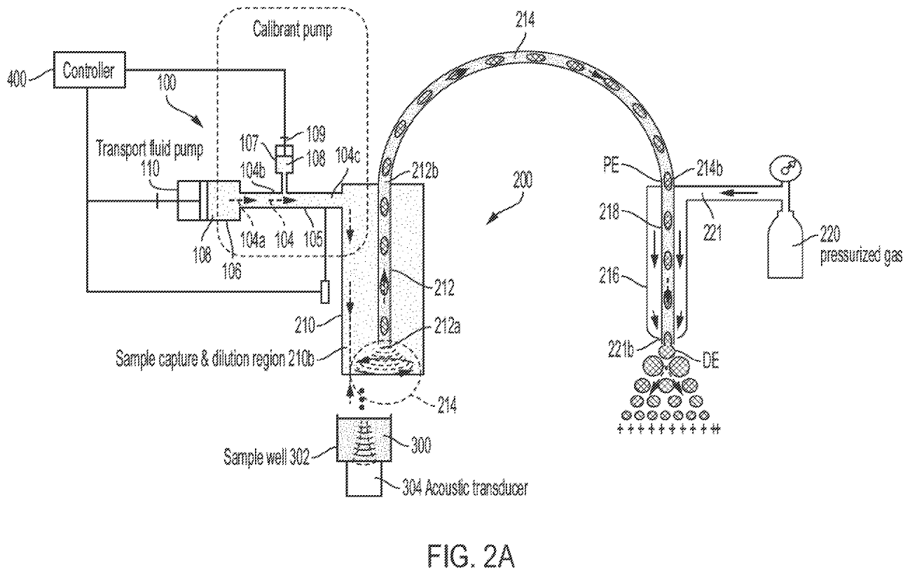

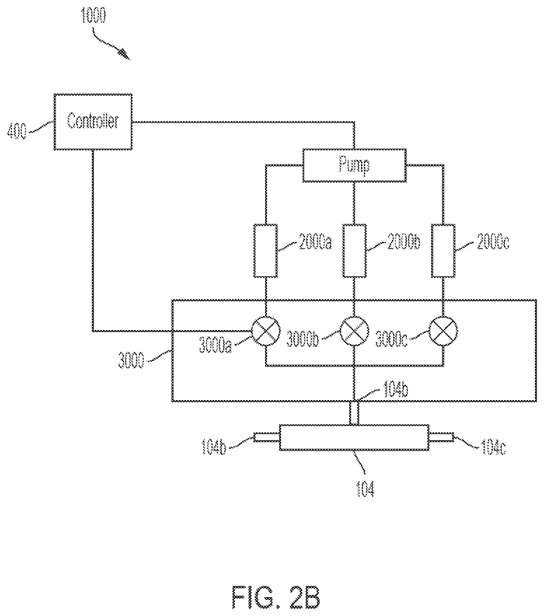

FIG. 2A schematically depicts a system 100 according to an embodiment for calibrating/tuning a mass spectrometer in which an OPI 102 sampling probe is employed for the introduction of a target sample into the mass spectrometer.

In this embodiment, the system 100 includes a fluidic junction 104 in the form of a T junction (herein also referred to as a T connection) having two inlets 104a and 104b via which a calibration solution and a transport liquid (herein also referred to as a carrier liquid) can be, respectively, introduced into the fluidic junction and an outlet 104c through which the transport liquid and the calibration solution (a mixture of the transport liquid and the calibration solution during calibration/tuning of the mass spectrometer) can exit the junction for introduction into the sampling probe 200.

More specifically, in this embodiment, a reservoir 106 in which a transport liquid 108 is stored is fluidly coupled to the inlet 104a of the fluidic junction 104 to introduce the transport liquid into the junction. A pump 110 is operably coupled to the reservoir 106 for providing a motive force for causing the flow of the transport liquid from the reservoir 106 into the fluidic junction via the inlet 104a thereof. The fluidic junction 104 includes a fluid channel 105 that extends from the inlet 104a to the outlet 104c and through which the transport liquid passes to be introduced into the sampling probe 200.

Some examples of suitable pumps that can be employed as the pump 110 include, without limitation, an HPLC pump, a reciprocating pump, a positive displacement pump, such as a rotary, a gear, a plunger, a piston, a peristaltic, a diaphragm pump, and other pumps such as gravity, impulse and centrifugal pump, all by way of non-limiting example.

The transport liquid can be any suitable liquid amenable to the ionization process. Some examples of suitable transport liquids include, without limitation, water, methanol, acetonitrile and mixtures thereof.

In this embodiment, the sampling probe 200 includes an outer conduit 210 (herein also referred as the liquid supply conduit) and an inner conduit 212 (herein also referred to as the liquid exhaust conduit), which is coaxially disposed relative to the outer conduit. In other embodiments, the liquid supply and liquid exhaust conduits can have other relative orientations. By way of example, in some such embodiments, the liquid exhaust conduit may surround the liquid supply conduit. An outlet end 210b of the liquid supply conduit delivers the transport liquid to an inlet end 212a of the liquid exhaust conduit 212 in a sampling space (that is, a sample capture and dilution region) 214 at an end of the sampling probe 200, which is open to the atmosphere and provides a liquid/air interface for receiving a target sample. As discussed in more detail below, the flow of the transport liquid from the liquid supply conduit into the liquid exhaust conduit helps transport a sample received via the liquid/air interface of the sampling probe 200 to a downstream ion source.

More specifically, in this embodiment, a sample 300 is contained within a sample well 302. An acoustic transducer 304 is operably coupled to the sample well so as to cause acoustic ejection of portions of the sample as a plurality of droplets into the sample capture and dilution region at the open liquid/air interface of the sampling probe 200. The sample droplets that are acoustically ejected into the liquid exhaust conduit are diluted and are entrained within the flow of the transport liquid for delivery to a downstream ion source.

More specifically, the diluted sample is carried via the transport liquid through an outlet 212b of the liquid exhaust conduit 212 into a connecting conduit 214, e.g., a tube, whose outlet 214b is fluidly coupled to an electrospray ionization (ESI) source 216 for delivery of the sample entrained within the transport liquid to the ESI source. In this embodiment, the ESI source includes an electrically conductive capillary 218 having a proximal end (PE) providing an inlet through which a mixture of the sample and the transport liquid enters the capillary and a distal end (DE) that extends into an ionization chamber and through which the liquid (e.g., a sample under analysis and/or a mixture of the transport liquid and the calibration solution) is discharged into the ionization chamber. An electrical potential difference (e.g., in a range of about 1000 volts to about 6000 volts) applied between the distal end of the electrically conductive capillary 212 and a counter electrode (not shown), e.g., a curtain plate of a downstream mass spectrometer, generates a strong electric field that causes ionization of at least a portion of the liquid as it is discharged from the capillary, thereby generating a plurality of charged droplets.

In this embodiment, a source 220 of pressurized gas (e.g., nitrogen, air, or a noble gas) can supply a nebulizing gas flow to a channel 221 of the ion source that surrounds the electrically conductive capillary 212 and includes an outlet 221b through which the nebulizing gas exits to surround the outlet end of the capillary tube and to interact with the liquid discharged therefrom so as to enhance the formation of a sample spray. The nebulizing gas can be supplied at a variety of flow rates, for example, at a flowrate in a range of about 0.1 μL/min to about 20 L/min.

The charged droplets can disintegrate due to coulomb repulsion to form a plurality of charged micro-droplets when the charge on the droplets is sufficiently high to overcome the surface tension of the liquid. As the solvent within the micro-droplets evaporates during desolvation in the ionization chamber, charged analyte ions can then enter a sampling orifice of the counter electrode for subsequent mass analysis.

With continued reference to FIG. 1, another reservoir 107 can store a quantity of a calibration solution and a pump 109 that is operably coupled to the reservoir can cause the flow of the calibration solution into the inlet 104b of the fluidic junction. The pump 109 can be any suitable pump, such as those listed above in connection with the above pump(s).

A controller 400 is operably coupled to the pumps 109 and 110 so as to control their operation. In order to perform calibration of the mass spectrometer, the controller 400 can activate the pump 109 to cause the flow of the calibration solution stored in reservoir 108 into the junction 104 via its inlet 104a. The calibration solution will mix with the transport liquid introduced into the junction via its inlet 104b (e.g., via activation of the pump 110 by the controller 400) and the mixture then exits the junction via its outlet 104c to be received by the sampling probe 200. The mixture of the calibration solution and the transport liquid is transferred into the ESI ion source via the liquid exhaust conduit of the sampling probe 200. The ions generated by the ionization of the calibration standard (calibrant) are received by the downstream components of the mass spectrometer.

When a calibration of the mass spectrometer is required, the controller 400 can send an activation signal to the calibration pump 109 to activate the pump so as to cause the flow of the calibration solution into the fluidic junction 104 such that the calibration solution is added to the OPI carrier flow (i.e., the transport liquid), generating a continuous infusion-like signal at the mass spectrometer.

Optionally, in some embodiments, prior to or substantially concurrent with the activation of the calibration pump 109, the controller 400 can send a signal to the pump 110 to adjust the speed of that pump in order to reduce the flowrate of the transport liquid so as to inhibit a potential overflow of liquid (e.g., a mixture of the calibration solution and the transport liquid) at the liquid/air interface of the sampling probe, especially when the calibration solution has a viscosity greater than that of the transport liquid (e.g., when water is used as the solvent for the calibration solution). Following the completion of the calibration/tuning process, the controller sends a signal to the calibration pump to turn off that pump.

In cases in which the controller had caused a reduction of the flowrate of the transport liquid during the calibration period, upon completion of the calibration/tuning process, the controller 400 sends a signal to the pump 110 to adjust that pump's speed in order to restore the flowrate of the transport liquid to its normal level (i.e., a level that is normally employed during sample analysis), e.g., its original setting prior to calibration.

FIG. 2B schematically depicts a calibration/tuning system 1000 according to another embodiment in which multiple reservoirs 2000a, 2000b, 2000c are employed for storing different calibration solutions, where each calibration solution contains a different calibration standard. A fluidic manifold 3000 operating under the control of the controller 400 can fluidly couple each of the reservoirs 2000a/2000b/2000c to the fluidic junction 104 so as to introduce different calibration solutions into the downstream ion source (not shown in this figure). More specifically, the fluidic manifold 3000 can include a plurality of switches 3000a, 3000b, and 3000c, each of which can be selectively activated via an activation signal supplied by the controller 400 to provide a fluidic path between a respective reservoir and the fluidic junction. As noted above, in some embodiments, the different calibration solutions may be employed for tuning/calibrating different operational modes (e.g., positive or negative ion modes) of a mass spectrometer and/or for tuning/calibrating different components (e.g., different mass analyzers) of a mass spectrometer. By way of example, in a hybrid mass spectrometer having at least one quadrupole mass analyzer and at least one time-of-flight mass analyzer, one calibration standard may be employed for tuning/calibrating the quadrupole mass analyzer and another calibration standard may be employed for tuning/calibrating the time-of-flight mass analyzer.

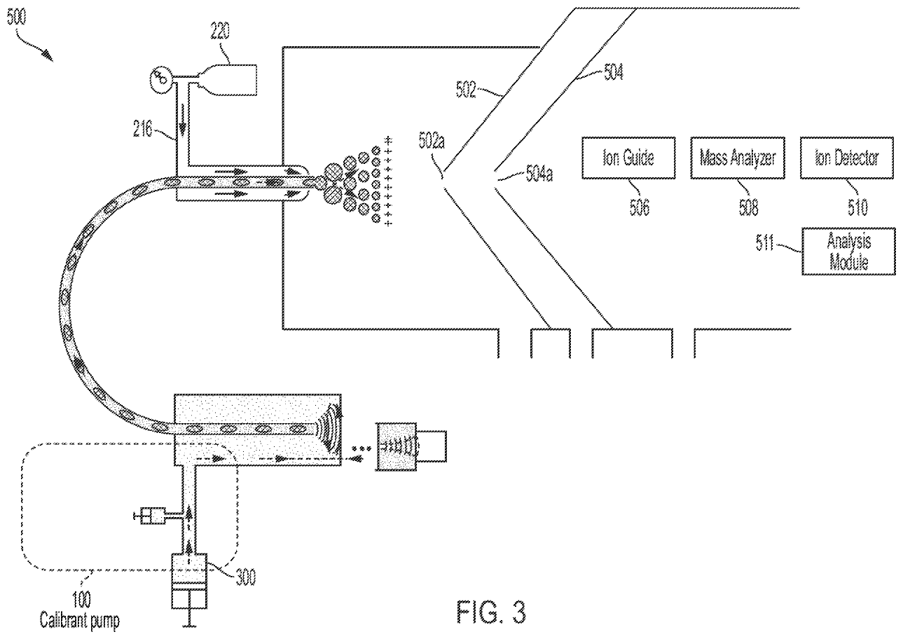

FIG. 3 shows a mass spectrometer 500 in which the above calibration/tuning system 100 according to an embodiment is incorporated. As discussed above, in this embodiment, the calibration/tuning system 100 is coupled to an OPI sample probe, which can receive a sample (specimen) for mass analysis from a sample reservoir 300, e.g., via acoustic ejection of the sample into the liquid/air interface of the OPI. Further, as discussed above, the sample introduced into the OPI is entrained within the flow of the transport liquid to be introduced into a downstream ESI source, which generates a plurality of ions. The gas source 220 provides a flow of a nebulizer gas that is configured to surround the discharge end of the ion source to shape the sample plume and/or assist in desolvation of charged micro-droplets.

The ions pass through an opening 502a of a curtain plate 502 (which in some embodiments can function as a counter-electrode of the ESI source) and an opening 504a of a downstream orifice plate 504 to reach an ion guide 506, which can form an ion beam via a combination of electromagnetic fields and gas dynamics. By way of example, the ion guide may be implemented as a multipole ion guide (e.g., a quadrupolar ion guide) having a plurality of elongated rods to which RF and/or DC voltages may be applied for providing a radial confinement of the ions. One or more mass analyzers 508 may be positioned downstream of the ion guide 506 for selecting ions having an m/z ratio of interest or an m/z ratio within a m/z range of interest. In this embodiment, the mass analyzer(s) can include a time-of-flight (TOF) mass analyzer, though other types of mass analyzers may also be employed, such as quadrupole mass analyzers.

An ion detector 510 positioned downstream of the mass analyzer(s) can receive the ions transmitted through the mass analyzer and generate ion detection signals. An analysis module 511 can receive the ion detection signals and process those signals to generate a mass spectrum of the target sample.

During a calibration process, rather than injecting a target sample into the mass spectrometer, a calibration solution having a calibration standard is introduced into the mass spectrometer, e.g., in a manner discussed above, and a mass spectrum of the calibration standard is generated, e.g., via the analysis module 511. The analysis module 511 can be further configured to process the mass peaks associated with the calibration standard to determine, e.g., the peak amplitudes, the areas under the peaks, and/or the minimum detectable separation between adjacent mass peaks, to arrive at certain characteristics, such as sensitivity and/or resolution, of the mass spectrometer.

In response to the determination of one or more characteristics of the mass spectrometer, such as those discussed above, one or more operating parameters of the mass spectrometer (e.g., DC and/or RF voltages applied to different components of the MS's ion guides) can be adjusted to calibrate/tune the mass spectrometer.

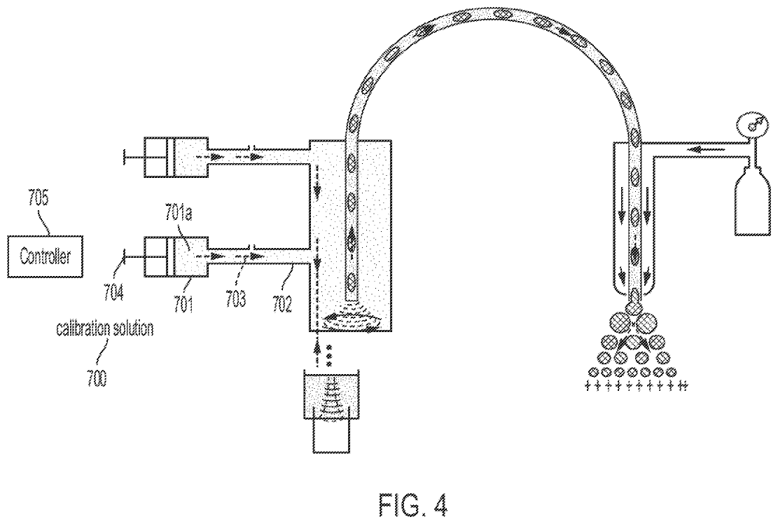

FIG. 4 schematically depicts a calibration/tuning system 700 according to another embodiment in which the calibration solution is introduced into the transport liquid flowing through the liquid supply conduit of an OPI sampling probe 702 via an inlet port 702a provided on a wall of the liquid supply conduit. More specifically, in this embodiment, a reservoir 701 containing a calibration solution 701a is fluidly coupled to the inlet port 702a via a fluid conduit 703. A pump 704 can provide the motive force for causing the flow of the calibration solution from the reservoir 701 into the transport liquid flowing through the liquid supply conduit of the OPI sampling probe.

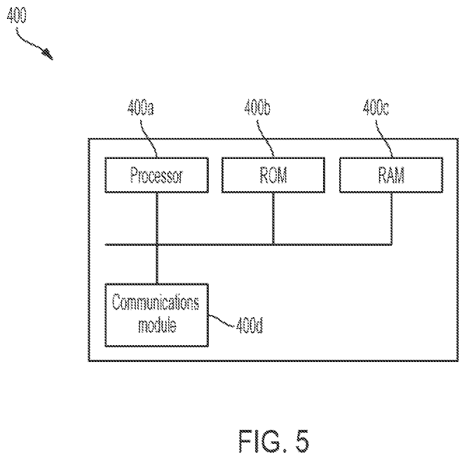

A controller and/or an analyzer employed in various embodiments of the present teachings can be implemented in hardware, firmware and/or software in a manner known in the art as informed by the present teachings. For example, FIG. 5 schematically depicts an example of an implementation of the controller 400, where the controller includes a processor 400a (e.g., a microprocessor), at least one permanent memory module 400b (e.g., ROM), at least one transient memory module (e.g., RAM) 400c, and a communications bus 400d, among other elements generally known in the art. The communications bus 400d allows communication between the processor and various other components of the controller. The controller 400 can further include a communications module 400e that is configured for transmission of control signals, e.g., the pumps employed to cause the flow of the calibration solution(s) and/or the transport liquid. Instructions for operating a tuning/calibration system according to various embodiments can be stored in the permanent memory module 400b and can be transferred into the transient memory module 400c during runtime for execution. In some embodiments, an analyzer for use in various embodiments, such as those discussed above, can be similarly implemented.

While particular embodiments of the present invention have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and the present disclosure may be beneficially implemented in any number of environments for any number purposes. Accordingly, the claims set forth below should be construed in view of the full breath and spirit of the present disclosure as described herein.

Although some aspects have been described in the context of a system and/or an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

What is claimed is:

1. A calibration system for use in a mass spectrometer having an open port interface (OPI) for receiving a sample for analysis, comprising:
a fluidic junction having a first inlet in fluid communication with a first reservoir containing a calibration liquid and a second inlet in fluid communication with a second reservoir containing a transport liquid, said fluidic junction further having an outlet in fluid communication with said first and second inlets such that any of the transport liquid and the calibration liquid can exit for introduction into said OPI,
a first pump operably coupled to said first reservoir for causing a flow of the calibration liquid from said first reservoir into said first inlet,
a second pump operably coupled to said second reservoir for causing a flow of the transport liquid from said second reservoir into said second inlet, and
a controller operably coupled to said first pump for controlling said first pump.

2. The calibration system of claim 1, further comprising a second pump operably coupled to said second reservoir for causing flow of the transport liquid from said second reservoir into said second inlet of the fluidic junction, and wherein said controller is operably coupled to said second pump for adjusting a pumping speed thereof, thereby adjusting a flowrate of said transport liquid.

3. The calibration system of claim 2, wherein said controller is configured to adjust a speed of said second pump so as to reduce the flowrate of the transport liquid during at least a portion of a temporal period during which the second pump is in an activated state.

4. The calibration system of claim 2, wherein said controller is configured to adjust the speed of the second pump so as to reduce the flowrate of the transport liquid prior to, or substantially concurrently with, or after activating said first pump for causing flow of the calibration liquid.

5. The calibration system of claim 1, wherein said controller is configured to reduce the flowrate of the transport liquid so as to inhibit overflow of a mixture of the transport liquid and the calibration liquid at a liquid/air interface of said OPI.

6. The calibration system of claim 1, further comprising a flow monitor coupled to said fluidic junction for monitoring a flowrate of liquid introduced into said OPI.

7. The calibration system of claim 6, wherein said controller is operably coupled to said flow monitor to receive one or more signals from said flow monitor indicative of the flowrate of the liquid flowing into said OPI via the outlet of said fluidic junction and wherein said controller is configured to adjust the flowrate of said transport liquid in response to said one or more signals received from the flow monitor.

8. The calibration system of claim 1, wherein said controller is configured to adjust the flowrate of said transport liquid so as to maintain a liquid/air interface of the OPI at a substantially uniform fluidic state.

9. The calibration system of claim 8, wherein said controller is configured to adjust the flowrate of the transport liquid so as to maintain a flowrate of liquid into the OPI at a substantially constant level.

10. (canceled)

11. (canceled)

12. A mass spectrometer, comprising:
an open port interface (OPI) for receiving a sample,
a first reservoir for storing a calibration liquid,
a second reservoir for storing a transport liquid,
a fluidic junction having a first inlet configured for fluid coupling with said first reservoir for receiving the transport liquid and a second inlet configured for fluid coupling with said second reservoir for receiving said calibration liquid, said fluidic junction further having an inlet in fluid communication with said first and second inlets and further configured for fluid communication with said OPI for introducing any of said transport liquid, said calibration liquid and a mixture thereof into said OPI,
a first pump operably coupled to said first reservoir for causing a flow of the calibration liquid into said fluidic junction,
a controller operably coupled to said first pump for controlling operation thereof.

13. The mass spectrometer of claim 12, wherein said controller is configured for activating said first pump to cause a flow of the calibration liquid into said fluidic junction for calibrating said mass spectrometer.

14. The mass spectrometer of claim 12, further comprising a second pump operably coupled to said second reservoir for causing a flow of the transport liquid into said fluidic junction, wherein said controller is operably coupled to said second pump for controlling operation thereof.

15. The mass spectrometer of claim 14, wherein said controller is configured to at least one of: (1) adjust a speed of said second pump so as to reduce the flowrate of the transport liquid into said fluidic junction during at least a portion of a temporal period during which said first pump is in an activated state; (2) to reduce the speed of said second pump prior to activating said first pump for reducing the flowrate of said transport liquid into said OPI so as to inhibit an overflow of a mixture of the transport liquid and the calibration liquid at a liquid/air interface of said OPI; and (3) to reduce the speed of said second pump substantially concurrently with activating said first pump.

16. The mass spectrometer of claim 12, wherein said OPI comprises an outer conduit and an inner conduit, wherein said outer conduit is configured to receive the transport liquid from the fluidic junction and to deliver said transport liquid to an inlet of the inner conduit in a sampling space at a liquid/air interface of said OPI.

17. The mass spectrometer of claim 12, further comprising a sample reservoir for containing a sample.

18. The mass spectrometer of claim 17, further comprising an acoustic transducer operably coupled to said sample reservoir for causing ejection of portions of said sample into said sampling space of the OPI such that said ejected portions of the sample are introduced into said inlet of the inner conduit and are entrained within a flow of said transport liquid to be transported to an outlet of said inner conduit of the OPI.

19. The mass spectrometer of claim 18, further comprising an ion source positioned downstream of said outlet of the inner conduit for receiving at least a portion of the sample exiting through the outlet of said inner conduit and ionizing at least a portion of the received sample to generate a plurality of ions and further comprising one or more mass analyzers for receiving at least a portion of said plurality of ions and generating a mass spectrum thereof, and wherein optionally said ion source comprise an ESI source and wherein optionally said one or more mass analyzers comprise any of a time-of-flight (TOF) mass analyzer, a quadrupole mass analyzer and a combination thereof.

20. A method of calibrating a mass spectrometer having an OPI for receiving a sample, comprising:
introducing a transport liquid into a fluidic junction via a first inlet thereof such that said transport liquid flows from said first inlet to an outlet of said fluidic junction that is in communication with said OPI for introduction of said transport liquid into the OPI, and
introducing a calibration solution into said fluidic junction via a second inlet thereof to be mixed with said transport liquid for introduction into said OPI via said outlet of the fluidic junction.
